(19) United States
(12) Patent Application Publication
(10) Pub. No.: US 2024/0056279 A1
(43) Pub. Date: Feb. 15, 2024

(54) COMMUNICATION SYSTEM

(71) Applicants: KABUSHIKI KAISHA TOSHIBA, Minato-ku, Tokyo (JP); TOSHIBA DIGITAL SOLUTIONS CORPORATION, Kawasaki-shi, Kanagawa (JP)

(72) Inventor: Atsushi KAKEMURA, Kokubunji, Tokyo (JP)

(73) Assignees: KABUSHIKI KAISHA TOSHIBA, Minato-ku, Tokyo (JP); TOSHIBA DIGITAL SOLUTIONS CORPORATION, Kawasaki-shi, Kanagawa (JP)

(21) Appl. No.: 18/259,303

(22) PCT Filed: Dec. 6, 2021
(86) PCT No.: PCT/JP2021/044616

§ 371 Date: Jun. 26, 2023

(30) Foreign Application Priority Data
Jan. 6, 2021 (JP) 2021-000968

(51) Int. Cl. H04L 5/14; H04W 72/30

(52) U.S. Cl. CPC H04L 5/14; H04W 72/30

(57) ABSTRACT

A communication system broadcasts utterance voice data of one of users to mobile communication terminals carried by respective users. Responsive to pressing an utterance button during a group calling communication mode in which a reception channel is established for utterance voice data transmitted from a server, the mobile communication terminal establishes a transmission channel transmitting utterance voice data to the server independently of the established reception channel, transmits utterance voice data from that mobile communication terminal, and receives utterance voice data within the communication group simultaneously. The mobile communication terminal stores a simultaneous connection upper limit in full-duplex transmission and a full-duplex transmission log including simultaneously connecting users and number of simultaneously connecting users. Limited full-duplex transmission control is performed on each terminal not permitting establishment of the transmission channel to the server based on the full-duplex transmission log and simultaneous connection upper limit.

### TECHNICAL FIELD

Embodiments of the present invention relate to a full-duplex transmission technique for use in group calling between multiple users.

### BACKGROUND ART

Communication by voice is performed, for example, with transceivers. A transceiver is a wireless device having both a transmission function and a reception function for radio waves and allowing a user to talk with a plurality of users (to perform unidirectional or bidirectional information transmission). The transceivers can find applications, for example, in construction sites, event venues, and facilities such as hotels and inns. The transceiver can also be used in radio-dispatched taxis, as another example.

### PRIOR ART DOCUMENT

### Patent Document

[Patent Document 1] Japanese Patent No. 4780397

### DISCLOSURE OF THE INVENTION

### Problems to be Solved by the Invention

It is an object of the present invention to provide a communication system capable of reducing a network channel load and a processing load to achieve smooth full-duplex transmission in group calling.

### Means for Solving the Problems

A communication system according to embodiments includes mobile communication terminals carried by users within a communication group and a communication server configured to broadcast utterance voice data received from one of the mobile communication terminals to the other mobile communication terminals within the communication group. Each of the mobile communication terminals includes a communication section configured to establish a reception channel for utterance voice data transmitted from the communication server to execute a group calling communication mode, and in response to pressing of an utterance button during the group calling communication mode, to establish a transmission channel for transmitting utterance voice data to the communication server independently of the established reception channel, and to transmit utterance voice data from that mobile communication terminal and receive utterance voice data within the communication group simultaneously; a storage section configured to store a simultaneous connection limit number in full-duplex transmission within the communication group and a full-duplex transmission log including simultaneously connecting users and the number of simultaneously connecting users; and a limited full-duplex transmission control section configured to perform limited full-duplex transmission control not to permit establishment of the transmission channel based on the full-duplex transmission log and the simultaneous connection upper limit.

### BRIEF DESCRIPTION OF THE DRAWINGS

FIG. 1 A diagram showing the configuration of a network of a communication system according to Embodiment 1.

FIG. 2 A block diagram showing the configurations of a communication management apparatus and a user terminal according to Embodiment 1.

FIG. 3 A diagram showing examples of various types of information according to Embodiment 1.

FIG. 4 A diagram for explaining limited full-duplex transmission control according to Embodiment 1.

FIG. 5 A diagram showing a flow of processing including limited full-duplex transmission control (A) in the communication system according to Embodiment 1.

FIG. 6 A diagram showing a flow of processing including limited full-duplex transmission control (B) in the communication system according to Embodiment 1.

FIG. 7 A diagram showing a flow of processing including limited full-duplex transmission control (C) in the communication system according to Embodiment 1.

FIG. 8 A diagram for explaining limited full-duplex transmission control according to Embodiment 2.

FIG. 9 A diagram showing a flow of processing including limited full-duplex transmission control (A)-1 in a communication system according to Embodiment 2.

FIG. 10 A diagram for explaining full-duplex calling log update and limit control in limited full-duplex transmission control according to Embodiment 2.

FIG. 11 A block diagram showing the configurations of a communication management apparatus and a user terminal according to Embodiment 3.

FIG. 12 A diagram for explaining a communication history in a communication system according to Embodiment 3.

FIG. 13 A diagram showing an example of the result of voice recognition in full-duplex transmission (full-duplex calling) according to Embodiment 3.

FIG. 14 A diagram showing an example of the result of voice recognition in full-duplex transmission (full-duplex calling) according to Embodiment 3.

FIG. 15 A diagram for explaining display processing based on the result of voice recognition according to Embodiment 3.

FIG. 16 A diagram for explaining display processing based on the result of voice recognition including regions in which utterances of multiple users overlap according to Embodiment 3.

### MODE FOR CARRYING OUT THE INVENTION

### Embodiment 1

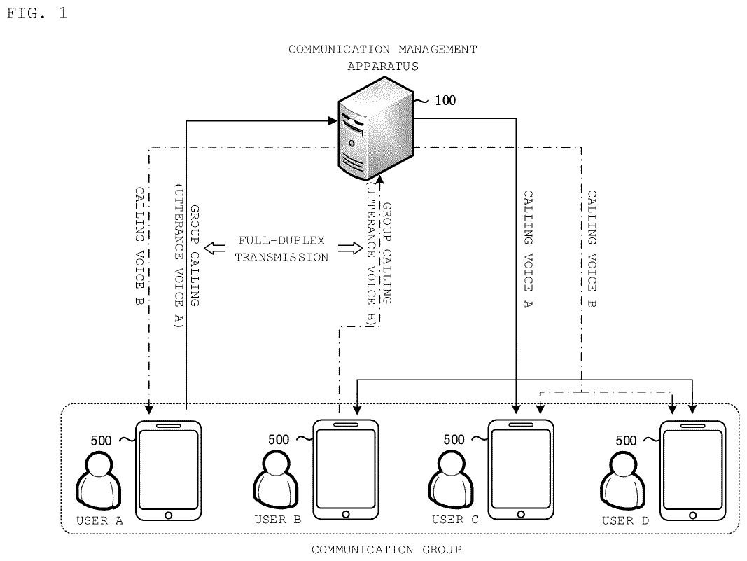

FIGS. 1 to 7 are diagrams for explaining Embodiment 1. FIG. 1 is a diagram showing the configuration of a network of a communication system according to Embodiment 1. The communication system provides an information transmission assistance function with a group calling communication mode such that a communication management apparatus (hereinafter referred to as a management apparatus) 100 plays a central role.

The management apparatus 100 is connected to user terminals (mobile communication terminals) 500 carried by respective users through wireless communication. The management apparatus 100 broadcasts utterance voice received from one of the user terminals 500 to the user terminals 500 in a communication group. The communication group is set to define the range in which the utterance voice of one of the users can be broadcast to the user terminals 500 of the other users. Each of the user terminals 500 of the relevant users is registered in the communication group.

The user terminal 500 may be a multi-functional cellular phone such as a smartphone, or a portable terminal (mobile terminal) such as a Personal Digital Assistant (PDA) or a tablet terminal. The user terminal 500 has a communication function, a computing function, and an input function, and connects to the management apparatus 100 through wireless communication over the Internet Protocol (IP) network or Mobile Communication Network to perform data communication.

The communication system according to Embodiment 1 provides an information transmission environment in which multiple users can interact with each other for sharing of recognition, conveyance of intention and other purposes, by way of example. The communication system can also provide an information transmission environment in which users can perform hands-free interaction with each other. The communication system can assist information transmission between users in various communication chains, for example to allow multiple employees in charge of facility management to contact each other for cooperation.

Calling schemes are now described. Group calling which allows for participation of multiple users includes calling based on half-duplex transmission and calling based on full-duplex transmission. The half-duplex transmission and full-duplex transmission are also referred to as a transceiver transmission scheme and a bidirectional transmission scheme, respectively.

The half-duplex transmission is a communication scheme in which transmission and reception of data cannot be performed simultaneously. For example, a user cannot perform utterance while hearing the utterance of a communication partner, and the user cannot hear any utterance of the communication partner while performing utterance. In general, the user needs to switch from transmission to reception each time he finishes his utterance as in a transceiver, and a single communication path (a single band) is shared between the transmission path and reception path for voice data. A specific mechanism is configured such that one of users presses an utterance button, and in response thereto, the other users are prevented from performing utterance. This causes only the utterance voice of the user having the utterance transmission right to be transmitted to the other users.

The full-duplex transmission is a communication scheme in which two data-flow paths are provided to allow simultaneous flows of data in different directions. Thus, this communication scheme enables multiple users to talk or hear simultaneously. Two communication paths (two bands) can be used for transmission and reception such that a user hears the utterance of a communication party while performing utterance.

The full-duplex transmission has a disadvantage of heavy network load due to a larger traffic amount resulting from the increased use of bands. As the number of participating users is increased, the load of processing transmission and reception of utterance voice is increased, which presents a disadvantage of large server load. Such a disadvantage has been addressed by a proposed technique of introducing a mechanism which allows a server side to limit the number of users who can perform utterance in the full-duplex transmission.

However, when the server side responsible for managing delivery of utterance voice to multiple users limits the number of users who can participate in the full-duplex transmission, the load of server processing is increased. This is because the server should concentratedly control Permitted/Not Permitted of utterance of each of the users.

In addition, the concentrated control of Permitted/Not Permitted of utterance on the server side has disadvantages including delayed utterance and missing beginning part of a talk.

Specifically, the control of Permitted/Not Permitted of utterance on the server side based on the limit requires a user (terminal) to ask the server if he can perform utterance before transmission of utterance voice to the server. As a result, the user cannot perform utterance before permission from the service even when he wishes utterance, or the user cannot transmit utterance after he performs it. This delays the timing of utterance to prevent smooth group calling.

The user tends to start talking immediately after pressing the utterance button. However, a time lag occurs between pressing of the utterance button and permission of the server after the server is asked if the user can perform utterance, and the content of utterance during the time lag is not included in utterance voice data transmitted after the permission. The voice data transmitted to the other users lacks the utterance content at the beginning of the talk.

To address this, the communication system according to Embodiment 1 imposes a limit on the number of users within the communication group who perform the full-duplex transmission, and the user terminal 500 controls the full-duplex transmission environment based on the limit. This can reduce the network channel load and the processing load to achieve smooth group calling including the full-duplex transmission.

As shown in FIG. 1, in the group calling communication mode, the management apparatus 100 establishes reception channels to the respective user terminals 500 through which the terminals 500 receive utterance voice data transmitted from the management apparatus 100. This enables the utterance voice of one of the users to be transmitted to and heard by the other users.

When the utterance button is pressed by a user during the group calling communication mode, a transmission channel to the user terminal 500 of that user is formed for transmitting utterance voice data to the management apparatus 100 independently of the established reception channel. The pressing of the utterance button by any user creates a full-duplex transmission environment for each user terminal 500 in which utterance voice data from that user is transmitted and utterance voice data from the users within the communication group is received bidirectionally at the same time. In the example of FIG. 1, a user A and a user B press the utterance button, and the full-duplex transmission environment is created for the two users. The other users only hear (receive) the utterances of the two users talking with each other in the full-duplex transmission.

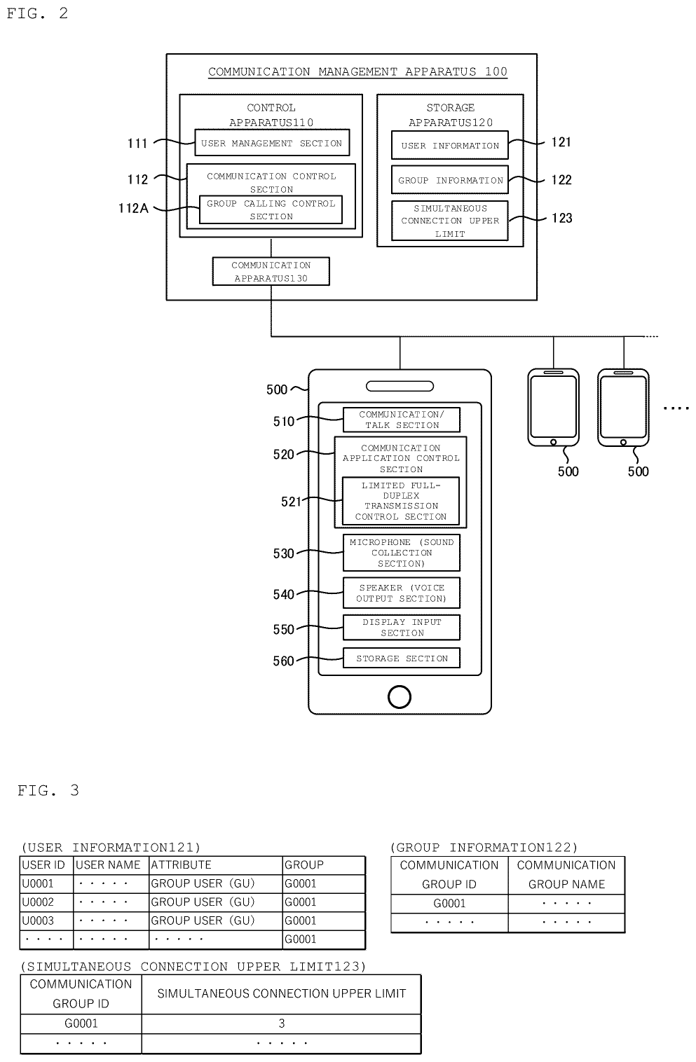

FIG. 2 is a block diagram showing the configurations of the management apparatus 100 and the user terminal 500. The management apparatus 130 includes a control apparatus 110, a storage apparatus 120, and a communication apparatus 130.

The communication apparatus 130 manages communication connection and controls data communication with the user terminals 500. The communication apparatus 130 controls broadcast to distribute utterance voice data from one of the users to the user terminals 500 at the same time in the group calling function. The communication apparatus 130 also establishes a transmission channel to the user terminal 500 of any user who wishes to perform utterance, thereby creating the environment for accepting utterance voice data while maintaining the reception channel to the user terminals 500.

The control apparatus 110 includes a user management section 111, a communication control section 112, and group calling control section 112A. The storage apparatus 120 includes user information 121, group information 122, simultaneous connection upper limit 123.

The user terminal 500 includes a communication/talk section 510, a communication application control section 520, a limited full-duplex transmission control section 521, a microphone 530, a speaker 540, a display input section 550 such as a touch panel, and a storage section 560. The speaker 540 is actually formed of earphones or headphones (wired or wireless).

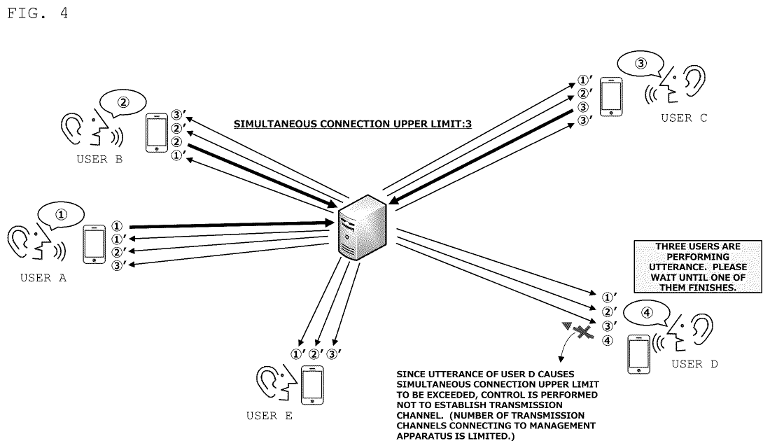

FIG. 3 is a diagram showing examples of various types of information. User information 121 is registered information about users of the communication system. The user management section 111 controls a predetermined management screen to allow setting of a user ID, user name, attribute, and group on that screen. The user management section 111 manages a list of correspondences between a history of log-ins to the communication system from the user terminals 500, the IDs of the users who logged in, and identification information of the user terminals 500 of those users (such as MAC address or individual identification information specific to each user terminal 500).

Group information 122 is group identification information representing separated communication groups. The management apparatus 100 controls transmission/reception and broadcast of information for each of the communication groups having respective communication group IDs to prevent mixed information across different communication groups. Each of the users in the user information 121 can be associated with the communication group registered in the group information 122. The user management section 111 according to Embodiment 1 controls registration of each of the users and provides a function of setting a communication group in which group calling is performed.

Any grouping can be set depending on the particular place or purpose for which the communication system according to Embodiment 1 is installed. For example, a facility can be classified into a plurality of divisions for management. In an example of an accommodation facility, bellpersons (porters), concierges, and housekeepers (cleaners) can be classified into different groups, and the communication environment can be established such that hotel room management is performed within each of those groups. In another viewpoint, communications may not be required for some tasks. For example, serving staff members and bellpersons (porters) do not need to directly communicate with each other, so that they can be classified into different groups. In addition, communications may not be required from geographical viewpoint. For example, when a branch office A and a branch office B are remotely located and do not need to frequently communicate with each other, they can be classified into different groups.

The simultaneous connection upper limit 123 is information for setting limited full-duplex transmission control and defines the number of users who can participate in full-duplex transmission. For example, the simultaneous connection upper limit 123 can be set by an administrator in the communication group operating the user terminal 500, logging in with the administrator right, and inputting the upper limit on a predetermined setting screen provided by the communication control section 112. The simultaneous connection upper limit 123 can also be input and set to the management apparatus 100 by an operational manager of the system on a predetermined management screen.

The communication control section 112 of the management apparatus 100 includes the group calling control section 112A which serves as a first control section. The first control section establishes a first channel to the respective user terminals 500 within the communication group who participate in the group calling communication mode to form a transmission path for utterance voice data (a reception channel from the viewpoint of the user terminal 500). The first control section also establishes a reception channel for utterance voice data in response to an utterance action (pressing of the utterance button) on the user terminal 500 to form a reception path (a transmission channel from the viewpoint of the user terminal 500).

The group calling control section 112A controls broadcast to transmit utterance voice data received from one of the user terminals 500 to the other user terminals 500. The group calling control section 112A can also transmit the utterance voice data to the user terminal 500 of the user who performed the utterance. In this case, the user terminal 500 of the user who performed the utterance can be configured to determine whether the transmitted data is his own utterance voice data, and discard the data without voice reproduction when the data is his own utterance voice data, or reproduce voice when the data is utterance voice data from any of the other users.

The utterance voice data received from the user terminal 500 can be configured to include information for identifying the user, for example the identification information of the user terminal 500 or the user ID. The group calling control section 112A can control transmission of the received utterance voice data to each user terminal 500 within the communication group such that the utterance voice data including the user identification information is broadcast.

The management apparatus 100 according to Embodiment 1 only broadcasts the utterance voice data received from one user terminal 500 to the user terminals 500 within the communication group and performs no control to select a user to whom the data should be transmitted or to accept utterance voice data individually from each user, thereby building a simple control system. Thus, the group calling control section 112A according to Embodiment 1 is configured to transmit the utterance voice data from the utterer to the user terminals 500 including the user terminal 500 of the utterer, and then the user terminals 500 perform control to reproduce or not to reproduce the voice, as described above.

FIG. 4 is a diagram for explaining the limited full-duplex transmission control according to Embodiment 1. As shown in FIG. 4, the simultaneous connection upper limit is first set. The simultaneous connection upper limit is registered on each of the user terminals 500 within the communication group.

The communication application control section 520 of the user terminal 500 establishes a reception channel to the management apparatus 100 for utterance voice data transmitted from the management apparatus 100 to execute the group calling communication mode. In response to pressing of the utterance button during the group calling communication mode, the communication application control section 520 also performs control to establish a transmission channel from the user terminal 500 for transmitting utterance voice data to the management apparatus 100 independently of the established reception channel to achieve simultaneous transmission of utterance voice data from that user terminal 500 and reception of utterance voice data within the communication group bidirectionally.

Specifically, in the example of FIG. 4, the user terminals 500 of users A to E enter the group calling communication mode and establish their respective reception channels to the management apparatus 100 for receiving utterance voice data. When the user A presses the utterance button and performs utterance, the user terminal 500 of the user A establishes a transmission channel to the management apparatus 100 for transmitting utterance voice data independently of the established reception channel to transmit utterance voice data to the management apparatus 100. The utterance voice data from the user A is delivered to the users B to E from the management apparatus 100. Since the utterance voice data includes user identification information, the reception of the utterance voice data at each of the user terminals 500 triggers counting of the users participating and performing utterance in the limited full-duplex transmission. When the count is less than the simultaneous connection upper limit, an additional user can perform utterance. When utterance of the additional user causes the simultaneous connection upper limit to be exceeded, utterance is limited.

The example FIG. 4 shows that the user A, the user B, and the user C press the utterance button and perform utterance. The simultaneous connection upper limit is set to 3. For example, when the user D presses the utterance button in an attempt to perform utterance, the user terminal 500 of the user D restricts utterance of the user D due to the limitation of the simultaneous connection upper limit. Specifically, the utterance voice data from each of the user A, the user B, and the user C is being received, and the count of uttering users is “3,” so that participation of the user D in the full-duplex transmission causes the simultaneous connection upper limit “3” to be exceeded. Even when the utterance button is pressed, the user terminal 500 of the user D can perform control not to establish a transmission channel to the management apparatus 100 and output a predetermined voice message. For example, a voice message can be output as “Three users are performing utterance. Please wait until one of them finishes.”

The limited full-duplex transmission control section 521 of the user terminal 500 stores the simultaneous connection upper limit on full-duplex transmission within the communication group and a full-duplex transmission log including simultaneously connecting users and the number of simultaneously connecting users in the storage section 560. The limited full-duplex transmission control section 521 updates the full-duplex transmission log based on utterance voice data received from the management apparatus 100 and performs the limited full-duplex transmission control for permitting or not permitting establishment of a transmission channel based on the full-duplex transmission log and the simultaneous connection upper limit.

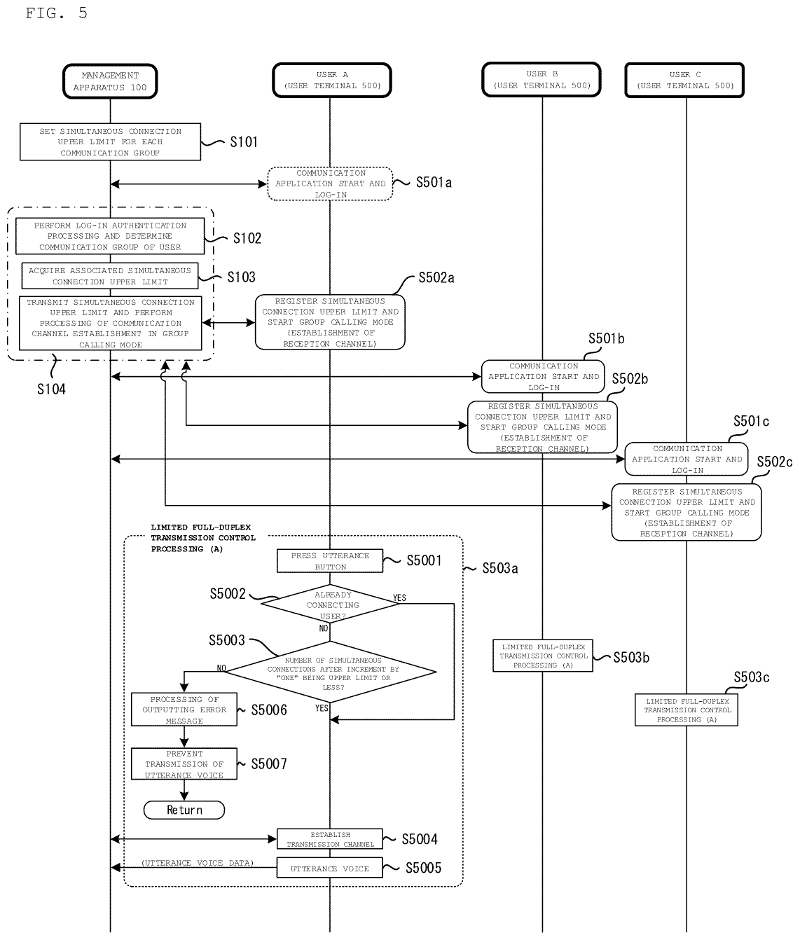

FIG. 5 is a diagram showing a flow of processing in the communication system according to Embodiment 1 (including limited full-duplex transmission control processing (A)). The management apparatus 100 receives setting (input) of the simultaneous connection upper limit for each communication group (S101) and stores the upper limit in the storage apparatus 120.

Each of the users starts the communication application control section 520 on his user terminal 500, and the communication application control section 520 performs processing for connection to the management apparatus 100. Each user enters his user ID and password on a predetermined log-in screen to log in to the management apparatus 100 (S501a, S501b, S501c). The log-in authentication processing is performed by the user management section 111 (S102). At the second and subsequent log-ins, the input operation of the user ID and password can be omitted since the started communication application control section 520 can automatically perform log-in processing with the user ID and password input by the user at the first log-in.

With the log-in authentication processing, the management apparatus 100 determines the communication group to which each user belongs (S102) and acquires the simultaneous connection upper limit set for each communication group (S103).

The management apparatus 100 transmits the acquired simultaneous connection upper limit to each of the user terminals 500 and automatically performs processing of communication channel establishment in a group calling communication mode to open a group calling channel centered around the management apparatus 100 (S104).

After the log-in, each user terminal 500 stores the received simultaneous connection upper limit in the storage section 560 and starts the group calling communication mode to establish a reception channel to the management apparatus 100 for utterance voice data (S502a, S502b, S502c). Thereafter, information acquisition processing is performed with the management apparatus 100 at any time or at predetermined time intervals.

The user A presses the utterance button, not shown, for performing utterance. The utterance button is a button provided for a predetermined screen on which the group calling mode is being executed.

In response to the pressing of the utterance button, the limited full-duplex transmission control section 521 of the user terminal 500 performs the limited full-duplex transmission control processing (A) at step S503a. When the utterance button is pressed (S5001), the limited full-duplex transmission control section 521 determines whether the user A (user themselves) is a user already participating in the full-duplex transmission (S5002). This determination can be made with reference to the full-duplex transmission log since the log has records of uttering users and the number of uttering users. In response to determination that the user A (user themselves) is a new participating user who is not recorded in the full-duplex transmission log, the limited full-duplex transmission control section 521 determines whether participation and utterance of the user A (user themselves) in the full-duplex transmission causes the simultaneous connection upper limit to be exceeded. In other words, the limited full-duplex transmission control section 521 determines whether incrementing the number of simultaneously connecting users in the full-duplex transmission log by “one” results in the number of simultaneously connecting users being equal to or less than the simultaneous connection upper limit (S5003).

In response to determination that incrementing the number of simultaneously connecting users in the full-duplex transmission log by “one” results in the number of simultaneously connecting users being equal to or less than the simultaneous connection upper limit (YES at S5003), the limited full-duplex transmission control section 521 performs processing of establishing a transmission channel associated with the pressing of the utterance button (S5004). The limited full-duplex transmission control section 521 then collects utterance voice and transmits the utterance voice data representing that voice to the management apparatus 100 (S5005).

Alternatively, In response to determination that incrementing the number of simultaneously connecting users in the full-duplex transmission log by “one” results in the number of simultaneously connecting users being larger than the simultaneous connection upper limit (NO at S5003), the limited full-duplex transmission control section 521 outputs a preset voice message (error message) (S5006) and performs control not to perform processing of establishing a transmission channel associated with the pressing of the utterance button (S5007).

As described above, the limited full-duplex transmission control processing (A) in FIG. 5 involves, in response to the pressing of the utterance button, determining whether the number of simultaneously connecting users after addition of a user (user themselves) not present among the simultaneously connecting users included in the full-duplex transmission log exceeds the simultaneous connection upper limit, and in response to determination that the simultaneous connection upper limit is exceeded, performing control not to perform processing of establishing a transmission channel associated with the pressing of the utterance button. This allows the user terminal 500 to control the number of uttering users to the upper limit or less, thereby achieving the full-duplex transmission environment with a reduced network load and a reduced processing load on the management apparatus 100. The same applies to steps S503b and S503c.

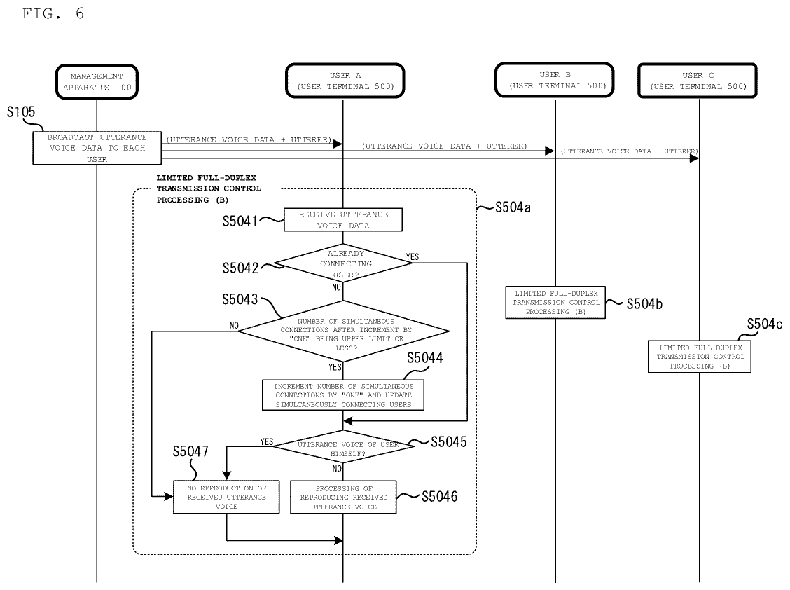

FIG. 6 is a diagram showing a flow of processing including limited full-duplex transmission control processing (B) in the communication system according to Embodiment 1. The limited full-duplex transmission control processing (B) at step S504a represents control performed in receiving utterance voice data from the management apparatus 100. The same applies to step S504b and S504c.

As shown in FIG. 6, each of the user terminals 500 receives utterance voice data including user identification information (utterer) from the management apparatus 100. Upon reception of the utterance voice data from the management apparatus 100 (S5041), the limited full-duplex transmission control section 521 performs first determination processing of determining whether the received utterance voice data is from one of the simultaneously connecting users included in the full-duplex transmission log (S5042).

In response to determination in the first determination processing that the received utterance voice data is from one of the users present in the full-duplex transmission log (YES at S5042), control proceeds to step S5045. Specifically, for any user participating as one of the simultaneously connecting users and maintaining the participation, whether the user is the utterer himself or not, control proceeds to processing of determining whether reproduction is permitted at step S5045 without performing limit determination based on the full-duplex transmission log.

Alternatively, in response to determination in the first determination processing that the received utterance voice data is from a new user who is not present in the full-duplex transmission log (NO at S5042), second determination processing is performed to determine whether the number of simultaneously connecting users after addition of the new user (increment by “one”) exceeds the simultaneous connection upper limit (S5043).

In response to determination in the second determination processing that the simultaneous connection upper limit is not exceeded, that is, that the number of users is equal to or less than the simultaneous connection upper limit (YES at S5043), the new user is added to update the full-duplex transmission log. The log is updated by adding the new user to the list of simultaneously connecting users and incrementing the number of simultaneously connecting users by “one” (S5044). Then, when the new user is the utterer himself, the received utterance voice data is discarded and reproduction thereof is not permitted (S5045). Specifically, the user terminal determines whether the received utterance voice data is from the utterer himself, and in response to determination that the data is from the utterer himself (YES at S5045), control is performed to discard the received utterance voice data and not to permit reproduction thereof (S5047). Alternatively, in response to determination that the utterance voice data is from one of the users other than the utterer himself (NO at S5045), the received utterance voice data is reproduced (S5046).

Alternatively, in response to determination at step S5043 (second determination processing) that the simultaneous connection upper limit is exceeded (NO at S5043), control proceeds to step S5047 to perform control to discard the received utterance voice data and not to permit reproduction thereof.

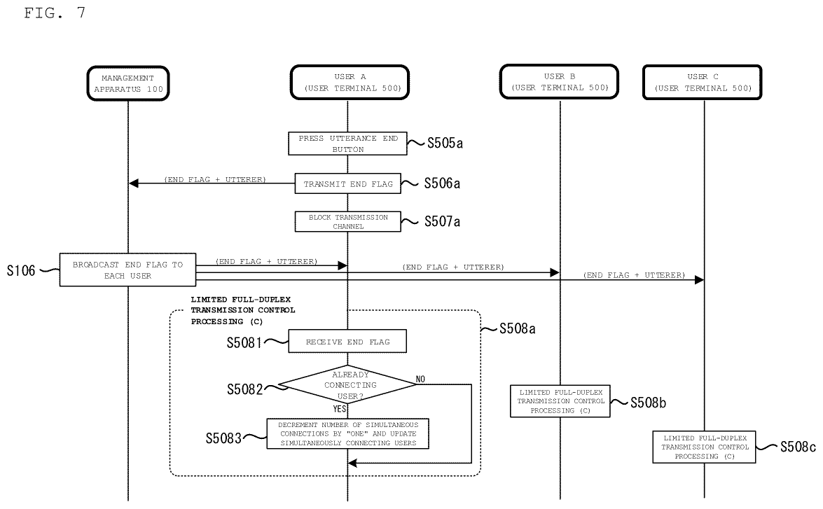

FIG. 7 is a diagram showing a flow of processing including limited full-duplex transmission control processing (C) in the communication system according to Embodiment 1. The limited full-duplex transmission control processing (C) at step S507a represents control performed in ending utterance in the full-duplex transmission.

The user A presses an utterance end button, not shown, for ending utterance (S505a). The utterance end button is a button provided for a predetermined screen on which the group calling mode is being executed.

In response to the pressing of the utterance end button, the limited full-duplex transmission control section 521 transmits an end flag to the management apparatus 100 through the transmission channel (S506a). In this case, the limited full-duplex transmission control section 521 can be configured to produce voice data including the end flag and transmit the voice data with the end flag to the management apparatus 100 over the connecting transmission channel. After the end flag is transmitted, the limited full-duplex transmission control section 521 blocks the transmission channel (S507a).

The group calling control section 112A of the management apparatus 100 receives the end flag and transmits the end flag to the respective user terminals 500 over the communication channels (reception channels from the viewpoint of the user terminals 500) (S106). In this case, similarly to the delivery of the utterance voice data, the group calling control section 112A can broadcast the received voice data with the end flag to the respective user terminals 500 within the communication group.

In response to reception of the end flag from the management apparatus 100 (S5081), the limited full-duplex transmission control section 521 checks whether the received end flag is from one of the users present in the full-duplex transmission log (S5082). After the presence in the full-duplex transmission log is checked, the limited full-duplex transmission control section 521 removes that user from the full-duplex transmission log and decrements the number of simultaneously connecting users by “one” (S5083).

### Embodiment 2

FIGS. 8 to 10 are diagrams for explaining Embodiment 2. FIG. 8 is a diagram for explaining limited full-duplex transmission control according to Embodiment 2 which differs from Embodiment 1 in control of establishing and blocking a transmission channel.

As shown in FIG. 8, in Embodiment 2, utterance voice data representing utterance of an utterer is delivered to the user terminals 500 including the user terminal 500 of the utterer as in Embodiment 1. In Embodiment 2, when the user D presses the utterance button, a transmission channel is established to transmit the utterance voice data to the management apparatus 100 without performing limit control. Then, the utterance voice data received from the management apparatus 100 is used to determine whether the user D (user themselves) can participate in full-duplex transmission based on the simultaneous connection upper limit. In response to determination that the user D cannot participate, the established transmission channel is blocked and closed.

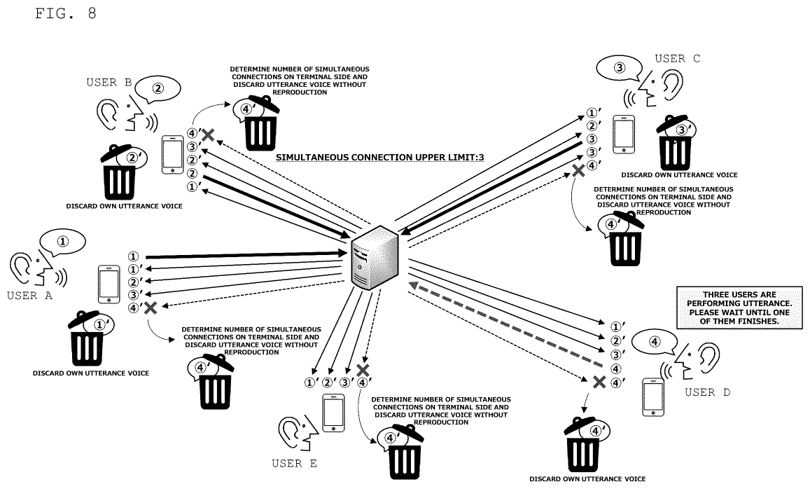

FIG. 9 is a diagram showing a flow of processing including limited full-duplex transmission control (A)-1 in the communication system according to Embodiment 2. In the following description, the same functions and operations as those in Embodiment 1 are designated with the same reference numbers, description thereof is omitted, and differences between Embodiments 1 and 2 are mainly described.

The limited full-duplex transmission control (A)-1 at step S5061a involves, in response to the user terminal of an utterer receiving utterance voice data originating from the utterer himself over the transmission channel, determining whether the number of simultaneously connecting users after addition of the utterer (user themselves) not present among the simultaneously connecting users included in the full-duplex transmission log exceeds the simultaneous connection upper limit, and in response to determination that the simultaneous connection upper limit is exceeded, performing control to block the transmission channel established in association with the pressing of the utterance button.

As shown in FIG. 9, after the log-in, each user terminal 500 stores the received simultaneous connection upper limit in the storage section 560 and starts the group calling communication mode to establish a reception channel to the management apparatus 100 for utterance voice data (S502a, S502b, S502c).

The user A presses the utterance button, not shown, for performing utterance. In response to the pressing of the utterance button (S5031a), the limited full-duplex transmission control section 521 of the user terminal 500 does not perform limit processing based on the simultaneous connection upper limit and the full-duplex transmission log in this case but performs processing of establishing a transmission channel triggered by the pressing of the utterance button (S5041a). The limited full-duplex transmission control section 521 then collects utterance voice and transmits the utterance voice data representing that voice to the management apparatus 100 (S5051a).

The management apparatus 100 broadcasts the received utterance voice data to all the users within the communication group including the utterer himself (S105). The utterance voice data includes user identification information.

The user terminal 500 receives the utterance voice data from the management apparatus (S5601). The limited full-duplex transmission control section 521 updates the full-duplex transmission log based on the utterance voice data representing the utterance from the utterer himself who received that data and the utterance voice data representing the utterances from the other users.

In response to the reception of the utterance voice data, the limited full-duplex transmission control section 521 performs first determination processing of determining whether the received utterance voice data is from one of the simultaneously connecting users included in the full-duplex transmission log (S5602). In response to determination in the first determination processing that the received utterance voice data is from one of the users present in the full-duplex transmission log (YES at S5602), control proceeds to step S5605. Specifically, for any user participating as one of the simultaneously connecting users and maintaining the participation, whether the user is the utterer himself or not, control proceeds to processing of determining whether reproduction is permitted at step S5605 without performing limit determination based on the full-duplex transmission log.

Alternatively, in response to determination in the first determination processing that the received utterance voice data is from a new user who is not present in the full-duplex transmission log (NO at S5602), second determination processing is performed to determine whether the number of simultaneously connecting users after addition of the new user exceeds the simultaneous connection upper limit, that is, whether the number of simultaneously connecting users after addition of the new user is equal to or less than the simultaneous connection upper limit (S5603).

In response to determination in the second determination processing that the simultaneous connection upper limit is not exceeded (YES at S5603), the new user is added to update the full-duplex transmission log (S5604). When the new user is the utterer himself (YES at S5605), control is performed to discard the received utterance voice data and not to permit reproduction thereof (not to reproduce it) (S5607). The transmission channel established in association with the pressing of the utterance button is maintained (S5608). Alternatively, when the new user is one of the users other than the utterer himself (NO at S5605), control is performed to permit reproduction of the received utterance voice data (S5606).

Alternatively, in response to determination in the second determination processing that the simultaneous connection upper limit is exceeded (NO at S5603), control is performed to discard the received utterance voice data and not to permit reproduction thereof. When the new user is the utterer himself (YES at S5609), control is performed to block the transmission channel established in association with the pressing of the utterance button (S5611) so as not to permit transmission channel establishment. As in Embodiment 1, a voice message can be output to indicate that the user cannot participate in simultaneous calling (S5610). Alternatively, when the utterance voice data is from one of the users other than the utterer himself at step S5609 (NO at S5609), control is performed to discard the received utterance voice data and not to reproduce the data regardless of block control of the transmission channel.

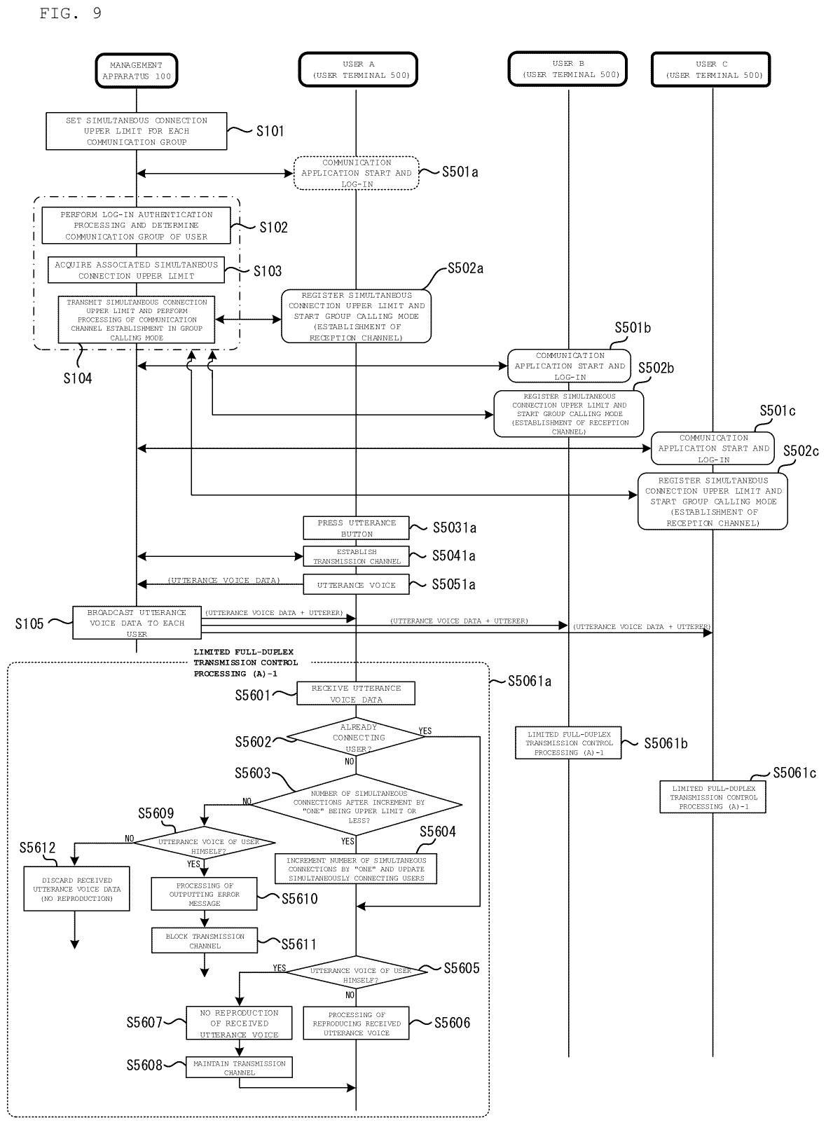

FIG. 10 shows the limited full-duplex transmission control (A)-1 corresponding to both of the limited full-duplex transmission control (A) shown in FIG. 5 and the limited full-duplex transmission control (B) shown in FIG. 6. The limited full-duplex transmission control (C) shown in FIG. 7 is similarly performed in Embodiment 2.

FIG. 10 is a diagram for explaining full-duplex transmission log update and limit control in the limited full-duplex transmission control according to Embodiment 2. In the example of FIG. 10, when a user 1 presses the utterance button and performs utterance, the utterance voice data representing the utterance is delivered to all the users including the user 1 from the management apparatus 100. The user terminal 500 of each of the users 1 to 7 undergoes the limited full-duplex transmission control (A)-1, and does not reproduce the utterance voice data of the utterer himself or reproduces the utterance voice data of the users other than the utterer.

In response to reception of the utterance voice data of the user 1, the “user 1” is added to the simultaneously connecting users in the full-duplex transmission log, and the number of simultaneously connecting users is updated to “one.” Subsequently, when the user 3 presses the utterance button and performs utterance, the utterance voice data is delivered to all the users including the user 3 from the management apparatus 100, and the limited full-duplex transmission control (A)-1 is performed similarly. In response to reception of the utterance voice data of the user 3, the “user 3” is added to the simultaneously connecting users in the full-duplex transmission log and the number of simultaneously connecting users is updated to “two.” Then, when the user 6 presses the utterance button and performs utterance, the utterance voice data is delivered to all the users including the user 6 from the management apparatus 100, and the limited full-duplex transmission control (A)-1 is performed similarly. In response to reception of the utterance voice data of the user 6, the “user 6” is added to the simultaneously connecting users in the full-duplex transmission log and the number of simultaneously connecting users is updated to “three.”

When the simultaneous connection upper limit is set to “three,” the upper limit is reached at this point since the user 1, the user 3, and the user 6 are participating in the full-duplex transmission. When the user 4 presses the utterance button and performs utterance in this state in which the upper limit is reached, the user terminal 500 of the user 4 establishes a transmission channel and transmits the utterance voice of the user 4 to the management apparatus 100. However, in response to reception of the utterance voice data delivered from the management apparatus 100, each user terminal 500 performs the limited full-duplex transmission control (A)-1 to discard the utterance voice data of the user 4 and not to permit reproduction thereof. The user terminal 500 of the user 4 closes the transmission channel to the management apparatus 100 and outputs an error message indicating that the user 4 cannot participate in the full-duplex transmission.

When the user 3 participating in the full-duplex transmission presses the utterance end button, the limited full-duplex transmission control section 521 transmits voice data with an end flag to the management apparatus 100 over the transmission channel. After the transmission of the flag, the limited full-duplex transmission control section 521 blocks the transmission channel.

The management apparatus 100 broadcasts the received voice data with the end flag to all the user terminals 500 including the user terminal 500 of the user 3 within the communication group. Each user terminal 500 removes the user identified by the received end flag from the full-duplex transmission log and decrements the number of simultaneously connecting users by “one.” As shown in FIG. 10, after the end of utterance of the user 3, the simultaneously connecting users in the full-duplex transmission log are “user 1 and user 6,” and the number of simultaneously connecting users is updated to “two.”

In Embodiment 2 and Embodiment 1 described above, the time of block of the transmission channel in response to pressing of the utterance end button in FIG. 7 may not be combined with the transmission of the voice data with the end flag. For example, the processing of blocking the established transmission channel may be triggered by the voice data with the end flag received by any of the users including the utterer from the management apparatus 100.

### Embodiment 3

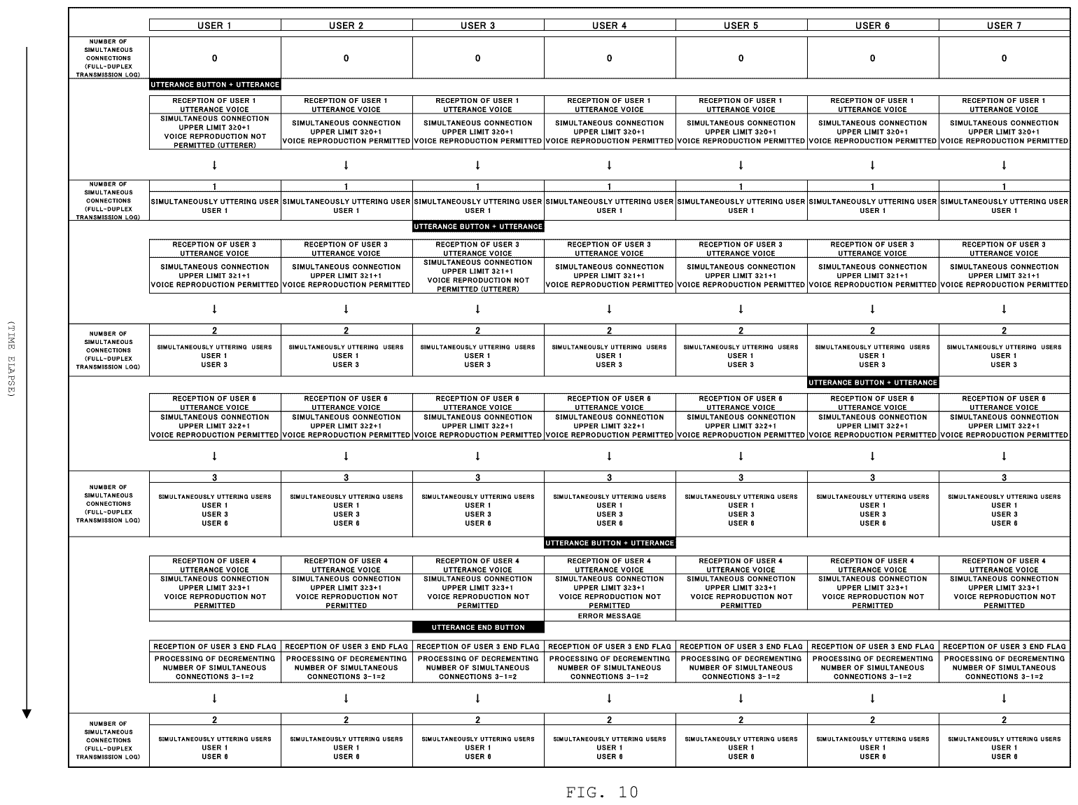

FIGS. 11 to 16 are diagrams for explaining Embodiment 3. Embodiment 3 is an aspect in which the communication systems according to Embodiment 1 and Embodiment 2 described above have a function of accumulating a communication history and displaying the communication history on each user terminal 500. In the following description, the same functions and operations as those in Embodiments 1 and 2 are designated with the same reference numbers, description thereof is omitted, and differences between Embodiments 1 and 2 and Embodiment 3 are mainly described.

FIG. 11 is a diagram showing the functional blocks of the communication system according to Embodiment 3 which additionally includes a voice recognition section 113, communication history information 124, and a voice recognition dictionary 125. Embodiment 3 provides the function of accumulating the result of voice recognition (utterance text) from voice recognition processing on user's utterance voice received by the management apparatus 100 as the communication history and displaying the communication history in synchronization on the respective user terminals 500 of the users within the communication group.

The group calling control section 112A of the management apparatus 100 controls not only broadcast of utterance voice data of the user as described above but also broadcast of the text information representing the content of the utterance (text information resulting from voice recognition processing on the utterance voice data) to the user terminals 500 at the same time.

The group calling control section 112A includes a first control section and a second control section. The first control section controls the above-mentioned broadcast of utterance voice data received from one of the user terminals 500 to the other user terminals 500 within the communication group. The second control section chronologically accumulates the result of utterance voice recognition from voice recognition processing on the received utterance voice data as the user-to-user communication history 124 and controls text delivery such that the communication history 124 is displayed in synchronization on all the user terminals 500 including the user terminal 500 of the user who performed the utterance.

Thus, all the voices reproduced on the user terminals 500 are converted into texts which in turn are accumulated chronologically in the communication history 124 and displayed on the user terminals 500 in synchronization. The voice recognition section 113 performs voice recognition processing with the voice recognition dictionary 125 to output text data as the result of utterance voice recognition. The voice recognition processing can be performed by using any of known technologies.

The communication history information 124 is log information including contents of utterance of the users, together with time information, accumulated chronologically on a text basis. Voice data corresponding to each of the texts can be stored as a voice file in a predetermined storage region, and in this case, the position of the stored voice file is also recorded in the communication history 124. The communication history information 124 is created and accumulated for each communication group.

FIG. 12 is a diagram showing an example of the communication history 124 displayed on the user terminals 500. Each of the user terminals 500 receives the communication history 124 from the management apparatus 100 in real time or at a predetermined time, and the display thereof is synchronized among the users. The users can chronologically refer to the communication log.

As in the example of FIG. 12, each user terminal 500 chronologically displays the utterance content of the user of that terminal 500 and the utterance contents of the other users in a display field D to share the communication history 124 accumulated in the management apparatus 100 as log information. In the display field D, each text representing user's own utterance may be accompanied by a microphone mark H, and the users other than the utterer may be shown by a speaker mark M instead of the microphone mark H in the display field D.

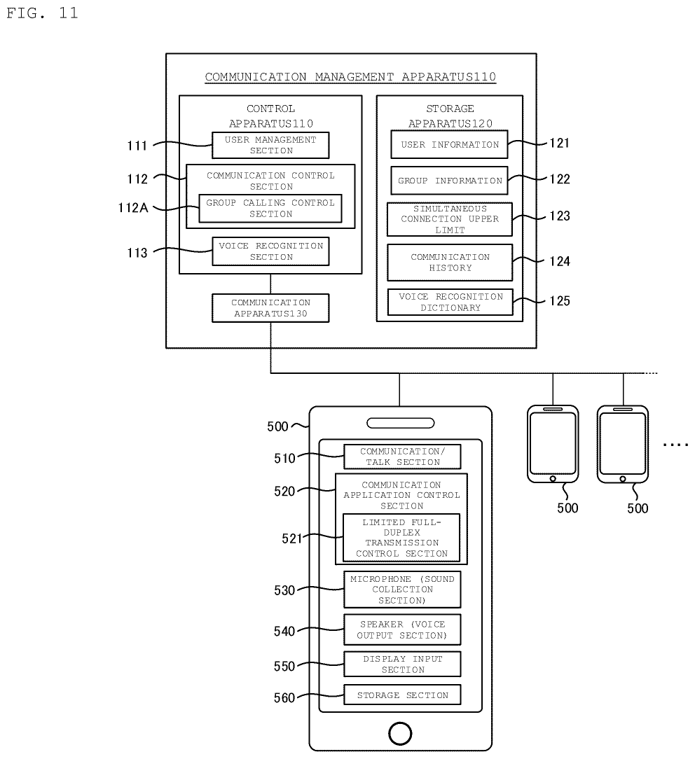

When two or more users bidirectionally interact with each other in full-duplex transmission, the text conversion and display technique based on the voice recognition described above may be used to perform the voice recognition and text conversion each time a continuous piece of voice representing utterance of each user is completed. However, if the voice data from the start to end of the continuous piece of utterance of each user simply undergoes voice recognition without identifying “exchanges of information in utterance” during the interaction, the intended “exchanges of information” between the users cannot be achieved as in the example of FIG. 13.

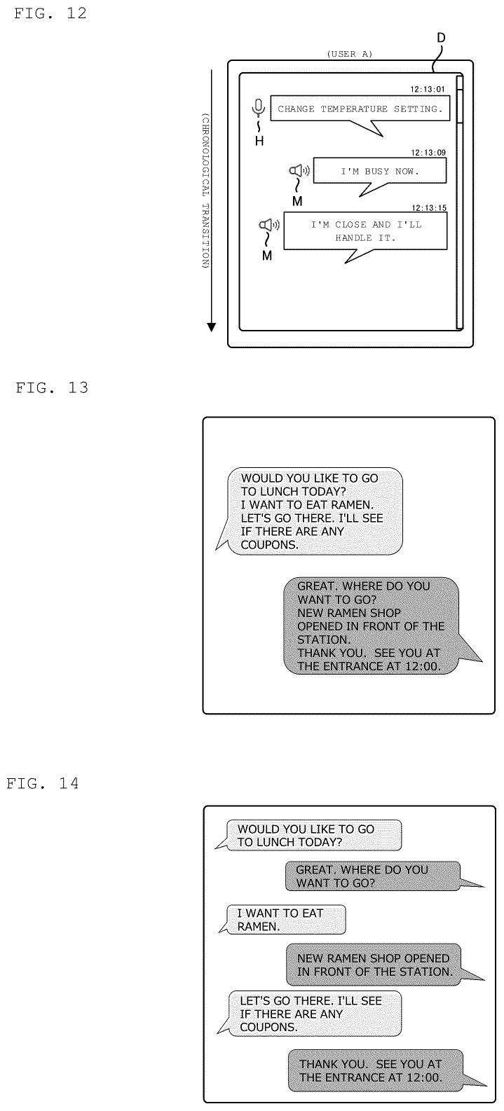

To display the communication history in view of the exchanges of information during the interaction, the voice recognition processing or the voice recognition result needs to be subdivided based on chronological information of the bidirectional conversation as shown in the example of FIG. 14. As the conversation is longer, it is more difficult to understand the conversation from the result of voice recognition as in the example of FIG. 13. Thus, in the full-duplex transmission, the voice recognition processing and text display need to be performed in view of chronological order of bidirectional conversation, that is, in view of the exchanges of information between the users.

To address this, the communication control section 112 according to Embodiment 3 receives a sequence of voice data including multiple utterances from each of the simultaneously connecting users in the full-duplex transmission, and when adjacent utterances of one of the users are spaced at a predetermined time interval or more, performs control to separately display the results of utterance voice recognition representing the respective adjacent utterances on the user terminal 500, or when adjacent utterances are spaced at less than the predetermined time interval, performs control to present unseparated display of the results of utterance voice recognition representing the respective adjacent utterances on the user terminal 500.

A zone including mixed utterance voices of multiple users is controlled such that the results of utterance voice recognition for the respective users are displayed within speech balloons in the order of start of the received user's utterance.

This configuration can provide the communication history in the full-duplex transmission between multiple users on each user terminal in an easy-to-understand fashion as in the example of FIG. 14.

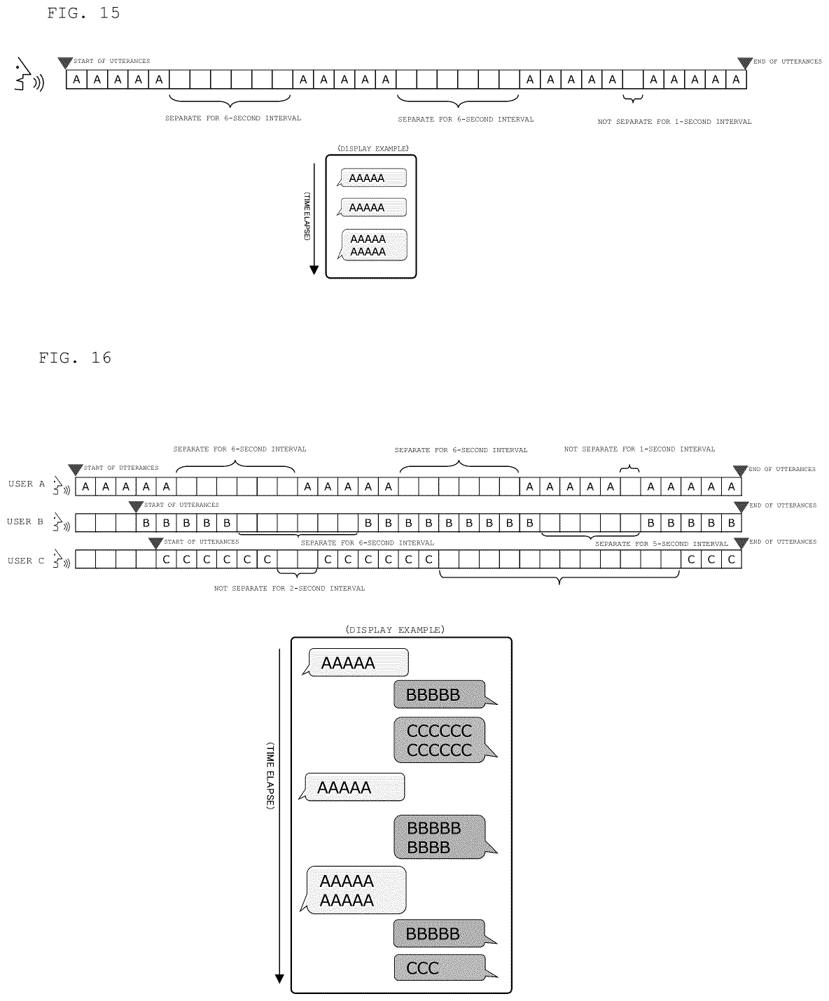

FIG. 15 is a diagram for explaining display processing based on the result of voice recognition according to Embodiment 3. For convenience of description, the zone from start to end of a series of utterances is shown with one block corresponding to one second. Alphabetical letters within the blocks represent the results of voice recognition of utterance voice. This also applies to FIG. 16.

In FIG. 15, utterance voice is recorded from the time of start of utterance, and after some time period, utterance voice is stored again. This represents exchanges of information in the full-duplex transmission in which a user performs utterance, hears the responding utterance of a communication partner, and again performs utterance in response to the utterance of the communication partner. In the example of FIG. 15, the utterance of the user himself is indicated by the alphabetical letters, and the state of hearing the communication partner's utterance is indicated by blanks.

In Embodiment 3, a setting value is defined for intervals between adjacent utterances in the zone from start to end of the series of utterances. For example, six seconds can be set. It should be noted that the setting value may be any seconds. When the interval between adjacent utterances is six seconds or longer, the results of utterance voice recognition of the adjacent utterances are separated, or when the interval is less than six seconds, the results of utterance voice recognition are not separated and combined together (the adjacent utterances are brought together). The arrangement control is performed as described above such that the results of utterance voice recognition are displayed chronologically within the respective speech balloons in the arranged regions.

FIG. 16 is a diagram for explaining display processing based on the result of voice recognition including regions in which utterances of multiple users overlap.

Similarly in FIG. 16, the users A, B, and C interact with each other in the full-duplex transmission, and in a zone from start to end of a series of utterances, a setting value is used to arrange adjacent utterances spaced at intervals for each user. The utterances of the users A, B, and C in the respective speech balloons are chronologically displayed based on the time of start of each arranged utterance.

Embodiments 1 to 3 of the present invention have been described. The functions of the communication management apparatus 100 and the user terminals 500 can be implemented by a program. A computer program previously provided for implementing the functions can be stored on an auxiliary storage apparatus, the program stored on the auxiliary storage apparatus can be read by a control section such as a CPU to a main storage apparatus, and the program read to the main storage apparatus can be executed by the control section to perform the functions of the respective components.

The program may be recorded on a computer readable recording medium and provided for the computer. Examples of the computer readable recording medium include optical disks such as a CD-ROM, phase-change optical disks such as a DVD-ROM, magneto-optical disks such as a Magnet-Optical (MO) disk and Mini Disk (MD), magnetic disks such as a floppy Disk® and removable hard disk, and memory cards such as a compact Flash®, smart media, SD memory card, and memory stick. Hardware apparatuses such as an integrated circuit (such as an IC chip) designed and configured specifically for the purpose of the present invention are included in the recording medium.

While the exemplary embodiments of the present invention have been described above, the embodiments are only illustrative and are not intended to limit the scope of the present invention. The novel embodiments can be implemented in other forms, and various omissions, substitutions, and modifications can be made thereto without departing from the spirit or scope of the present invention. These embodiments and variations are encompassed within the spirit or scope of the present invention and within the invention set forth in the claims and the equivalents thereof.

### DESCRIPTION OF THE REFERENCE NUMERALS

100 COMMUNICATION MANAGEMENT APPARATUS
110 CONTROL APPARATUS
111 USER MANAGEMENT SECTION
112 COMMUNICATION CONTROL SECTION
112A GROUP CALLING CONTROL SECTION
113 VOICE RECOGNITION SECTION
120 STORAGE APPARATUS
121 USER INFORMATION
122 GROUP INFORMATION
123 SIMULTANEOUS CONNECTION UPPER LIMIT
124 COMMUNICATION HISTORY INFORMATION
125 VOICE RECOGNITION DICTIONARY
130 COMMUNICATION APPARATUS
500 USER TERMINAL (MOBILE COMMUNICATION TERMINAL)
510 COMMUNICATION/TALK SECTION
520 COMMUNICATION APPLICATION CONTROL SECTION
521 LIMITED FULL-DUPLEX TRANSMISSION CONTROL SECTION
530 MICROPHONE (SOUND COLLECTION SECTION)
540 SPEAKER (VOICE OUTPUT SECTION)
550 DISPLAY INPUT SECTION
560 STORAGE SECTION
D DISPLAY FIELD

1. A communication system comprising mobile communication terminals carried by users within a communication group and a communication server configured to broadcast utterance voice data received from one of the mobile communication terminals to each of the mobile communication terminals within the communication group,
wherein each of the mobile communication terminals includes:
a communication section configured to establish a reception channel for utterance voice data transmitted from the communication server to execute a group calling communication mode, and in response to pressing of an utterance button by the user of the mobile communication terminal during the group calling communication mode, to establish a transmission channel for transmitting utterance voice data to the communication server independently of the established reception channel, and to transmit utterance voice data from that user and receive utterance voice data within the communication group simultaneously;
a storage section configured to store a simultaneous connection upper limit in full-duplex transmission within the communication group and a full-duplex transmission log including simultaneously connecting users and the number of simultaneously connecting users; and
a limited full-duplex transmission control section configured to perform limited full-duplex transmission control not to permit establishment of the transmission channel based on the full-duplex transmission log and the simultaneous connection upper limit.

2. The communication system according to claim 1, wherein the limited full-duplex transmission control section is configured to:
update the full-duplex transmission log based on utterance voice data within the communication group received from the communication server; and
in response to pressing of the utterance button by the user of the mobile communication terminal including that limited full-duplex transmission control section, determine whether the number of simultaneously connecting users after addition of that user not present among the simultaneously connecting users included in the full-duplex transmission log exceeds the simultaneous connection upper limit, and in response to determination that the simultaneous connection upper limit is exceeded, perform control not to perform processing of establishing the transmission channel associated with the pressing of the utterance button.

3. The communication system according to claim 2, wherein the limited full-duplex transmission control section is configured to:
in response to reception of utterance voice data from the communication server, perform first determination processing of determining whether the received utterance voice data is from one of the simultaneously connecting users included in the full-duplex transmission log, and in response to determination in the first determination processing that the received utterance voice data is from a new user not present in the full-duplex transmission log, perform second determination processing of determining whether the number of simultaneously connecting users after addition of the new user exceeds the simultaneous connection upper limit;
in response to determination in the second determination processing that the simultaneous connection upper limit is not exceeded, add the new user to update the full-duplex transmission log, and when the new user is the user who performed utterance represented by the utterance voice data, perform control to discard the received utterance voice data and not to permit reproduction thereof; and
in response to determination that the simultaneous connection upper limit is exceeded, perform control to discard the received utterance voice data and not to permit reproduction thereof.

4. The communication system according to claim 1, wherein the limited full-duplex transmission control section is configured to transmit utterance voice data of the user of the mobile communication terminal including that limited full-duplex transmission control section over the transmission channel, and in response to reception of the utterance voice data from the communication server, determine whether the number of simultaneously connecting users after addition of that user not present among the simultaneously connecting users included in the full-duplex transmission log exceeds the simultaneous connection upper limit, and in response to determination that the simultaneous connection upper limit is exceeded, block the transmission channel established in association with the pressing of the utterance button.

5. The communication system according to claim 4, wherein the limited full-duplex transmission control section is configured to:
update the full-duplex transmission log based on utterance voice data received from the communication server and originating from the user of the mobile communication terminal including that limited full-duplex transmission control section and utterance voice data received from the communication server and originating from the other users;
in response to reception of utterance voice data from the communication server, perform first determination processing of determining whether the received utterance voice data is from one of the simultaneously connecting users included in the full-duplex transmission log, and in response to determination in the first determination processing that the received utterance voice data is from a new user not present in the full-duplex transmission log, perform second determination processing of determining whether the number of simultaneously connecting users after addition of the new user exceeds the simultaneous connection upper limit;
in response to determination in the second determination processing that the simultaneous connection upper limit is not exceeded, add the new user to update the full-duplex transmission log, and when the new user is the user who performed utterance represented by the utterance voice data, perform control to discard the received utterance voice data and not to permit reproduction thereof, and maintain the transmission channel established in association with the pressing of the utterance button, and when the new user is another user, permit reproduction of the received utterance voice data; and
in response to determination that the simultaneous connection upper limit is exceeded, perform control to discard the received utterance voice data and not to permit reproduction thereof, and when the new user is the user who performed utterance represented by the utterance voice data, block the transmission channel established in association with the pressing of the utterance button.

6. The communication system according to claim 1, wherein the limited full-duplex transmission control section is configured to output a message indicating that participation in simultaneous calling is not possible when establishment of the transmission channel is not permitted.

7. The communication system according to claim 1, wherein the limited full-duplex transmission control section is configured to, in response to pressing of an utterance end button, transmit an end flag to the communication server over the transmission channel and block the transmission channel, and
the limited full-duplex transmission control section is configured to, in response to reception of the end flag from the communication server, remove the user associated with the received end flag from the full-duplex transmission log and decrement the number of simultaneously connecting users.

8. The communication system according to claim 7, wherein the limited full-duplex transmission control section is configured to, in response to pressing of the utterance end button, produce voice data including the end flag and transmit the voice data with the end flag to the communication server over the connecting transmission channel, and
the communication server is configured to broadcast the received voice data with the end flag to each of the mobile communication terminals within the communication group.

9. The communication system according to claim 1, wherein the communication server includes a communication control section configured to perform first processing of broadcasting utterance voice data received from one of the mobile communication terminals to each of the mobile communication terminals within the communication group and second processing of chronologically accumulating a result of utterance voice recognition from voice recognition processing on the received utterance voice data as a communication history and controlling text delivery such that the communication history is displayed on the mobile communication terminals in synchronization, and
the communication control section is configured to:
receive a sequence of voice data including multiple utterances from each of the simultaneously connecting users, and when adjacent utterances of one of the users are spaced at a predetermined time interval or more, perform control to separately display results of utterance voice recognition representing the respective adjacent utterances on the mobile communication terminal, and when adjacent utterances are spaced at less than the predetermined time interval, perform control to present unseparated display of the results of utterance voice recognition representing the respective adjacent utterances; and
control a zone including mixed utterances of multiple users such that results of utterance voice recognition for the respective users are displayed within speech balloons in the order of start of utterance of each user received by the communication server.

10. A program comprising instructions executable by mobile communication terminals in a communication system in which utterance voice input through one of the mobile communication terminals carried by users within a communication group is broadcast to each of the mobile communication terminals within the communication group via a communication server, wherein the instructions, when executed by the mobile communication terminal, cause the mobile communication terminal to provide:
a first function of establishing a reception channel for utterance voice data transmitted from the communication server to execute a group calling communication mode, and in response to pressing of an utterance button by the user of the mobile communication terminal during the group calling communication mode, establishing a transmission channel for transmitting utterance voice data to the communication server independently of the established reception channel, and transmitting utterance voice data from that user and receiving utterance voice data within the communication group simultaneously;
a second function of storing a simultaneous connection upper limit in full-duplex transmission within the communication group and a full-duplex transmission log including simultaneously connecting users and the number of simultaneously connecting users; and
a third function of performing limited full-duplex transmission control not to permit establishment of the transmission channel based on the full-duplex transmission log and the simultaneous connection upper limit.

11. A mobile communication terminal for use in a communication system in which the mobile communication terminal comprises a plurality of mobile communication terminals and utterance voice input through one of the mobile communication terminals carried by users within a communication group is broadcast to each of the mobile communication terminals within the communication group via a communication server, the mobile communication terminal comprising:
a communication section configured to establish a reception channel for utterance voice data transmitted from the communication server to execute a group calling communication mode, and in response to pressing of an utterance button by the user of the mobile communication terminal during the group calling communication mode, to establish a transmission channel for transmitting utterance voice data to the communication server independently of the established reception channel, and to transmit utterance voice data from that user and receive utterance voice data within the communication group simultaneously;
a storage section configured to store a simultaneous connection upper limit in full-duplex transmission within the communication group and a full-duplex transmission log including simultaneously connecting users and the number of simultaneously connecting users; and
a limited full-duplex transmission control section configured to perform limited full-duplex transmission control not to permit establishment of the transmission channel based on the full-duplex transmission log and the simultaneous connection upper limit.
